(19) United States
(12) Patent Application Publication
(10) Pub. No.: US 2025/0308174 A1
(43) Pub. Date: Oct. 2, 2025

(54) EXPERIENCE PLATFORM

(71) Applicant: TAIT TOWERS MANUFACTURING, LLC, Lititz, PA (US)

(72) Inventors: Adam DAVIS, Leola, PA (US); James D. LOVE, Lititz, PA (US); Francois BERGERON, Los Angeles, CA (US); Dave WEATHERHEAD, Winchester (GB)

(21) Appl. No.: 19/092,275

(22) Filed: Mar. 27, 2025

Related U.S. Application Data
(60) Provisional application No. 63/571,762, filed on Mar. 29, 2024.

(51) Int. Cl. G06T 19/00; A63F 13/58

(52) U.S. Cl. CPC G06T 19/006; A63F 13/58; A63F 2300/8082

(57) ABSTRACT

An experience platform system to provide customized experiences for guest, crowds or individuals that integrates the physical and digital worlds that are safe and secure, real-time, and scalable to engage the audiences in an individual manner. The experience platform system includes a physical world element, a virtual world element, and an experience controller that integrates the physical world element and the virtual world element. The integrating includes control of one or both of the physical world element and the virtual world element.

### RELATED APPLICATIONS

This application claims priority benefit to provisional patent application 63/571,762, entitled “EXPERIENCE PLATFORM”, filed on Mar. 29, 2024, the entirety of which are incorporated by reference herein.

### FIELD OF THE INVENTION

The present disclosure is generally directed to a control system for providing experiential control, including physical world and virtual world integrations in real-time.

### BACKGROUND OF THE INVENTION

In recent years consumers have been increasing their preferences for customized/personalized experiences when they visit entertainment venues, live entertainment events, transportation venues, such as airports or train stations, or other public spaces. One of the key challenges for amusement parks is creating unique, personalized experiences for guests that feel both immersive and personalized. With advancements in technology, guests have become more tech-savvy and can easily recognize the methods behind certain special effects or immersive elements. This makes it difficult to create experiences that continue to feel special or surprising. Guests now often expect a higher level of personalization in their interactions with the park. Meeting these expectations without revealing the mechanisms behind the experience is a significant challenge for park operators, who must find new ways to keep guests engaged and entertained.

In addition to guest expectations, there are challenges to managing individuals and crowds, particularly when there are large numbers of people at the venue or event. For example, amusement parks are designed to provide various entertainment options, such as rides, shows, and immersive experiences, to attract a wide range of guests. Attractions like roller coasters or virtual, augmented or extended reality systems offer guests thrilling experiences. However, due to the increasing popularity of these venues, many attractions can reach full capacity quickly and may result in a loss of quality of the experience for the guest, especially during peak times. One example is that guests often have to wait in long queues before experiencing the desired attraction. The wait time can be influenced by various factors, including the number of people already in line, the duration of the attraction's operational cycle, and the capacity of each cycle. These long wait times can negatively impact the overall guest experience and reduce customer satisfaction. It is desirable to reduce the wait time for these attractions, but also provide a customized experience

With the growing popularity of experiential venues and attractions, the number of daily visitors has increased significantly, and more complex attractions have been added to accommodate the influx of guests. While adding new attractions can increase a venue's capacity, it doesn't always reduce wait times or improve the overall guest experience. In fact, the increased attendance can have the opposite effect, leading to longer queues and overcrowded spaces. Negative experiences, such as long wait times, can deter visitors from returning, which makes it crucial for venues to develop better crowd control strategies to ensure a positive guest experience.

Venues also face maintenance challenges as visitor numbers grow. Increased traffic and usage of attractions can put additional stress on equipment and staffing, requiring more frequent maintenance, cleaning and/or repairs. Without a robust system for tracking and maintaining these attractions, the venue risks experiencing more breakdowns or downtime, which can result in guest dissatisfaction. Improving maintenance methods, including proactive monitoring and rapid response systems, can help mitigate these issues and ensure that attractions are consistently available for guests.

In addition to the above, access control and ticketing systems are critical in managing large volumes of visitors efficiently. Traditional paper ticketing methods are increasingly being replaced by more advanced systems, such as biometric data collection (e.g., fingerprint or facial recognition). While these systems can streamline the entry process and reduce the need for physical tickets, they present new challenges in terms of data storage and computational resources as well as management of the systems by staff. As the number of guests increases, so does the complexity of processing biometric data, which can lead to delays or errors. Moreover, the implementation of such systems requires careful coordination across large venues and many systems to ensure that access control is efficient and reliable, without causing frustration or bottlenecks.

What is needed is an experience platform that provides integration of various systems, including physical and virtual world elements within those systems to provide customized experiences for guests, crowds or individuals and management and control of multiple systems across the venue in real-time that does not suffer from the drawbacks of the prior art. Other features and advantages will be made apparent from the present specification. The teachings disclosed extend to those embodiments that fall within the scope of the claims, regardless of whether they accomplish one or more of the aforementioned needs.

### SUMMARY OF THE INVENTION

The application generally relates to an experience platform system to provide customized experiences for guest, crowds or individuals that integrates the physical and digital worlds that are safe and secure, real-time, and scalable to engage the audiences in an individual manner.

One embodiment of the present disclosure is directed to an experience platform system having a physical world element, a virtual world element, and an experience controller that integrates the physical world element and the virtual world element. The integrating includes real-time control of one or both of the physical world element and the virtual world element.

Another embodiment of the present disclosure includes a method for providing an entertainment experience. The method includes providing a physical world element, providing a virtual world element, and integrating the physical world element and the virtual world element to provide real-time control of one or both of the physical world element and the virtual world element.

Another embodiment of the present disclosure includes an experience platform system for providing real-time control of one or both of the physical world element and the virtual world element. The system includes a plurality of nodes and an operator console node in communication with each other over a real time network. One or both of a node of the plurality of nodes or the operator console node corresponds to the physical world element. One or both of a node of the plurality of nodes or the operator console node corresponds to virtual world element. Each node of the plurality of nodes and the operator console node includes a microprocessor and a memory device. The operator console node further includes an integrator for integrating the physical world element and the virtual world element. The system provides real-time control of the physical world element in response to the integration of the physical world element and the virtual world element.

The experience platform system according to the present disclosure provides experience controllers that provide a combination of technologies. For example, in one embodiment, experience controller combines physical world elements with virtual world elements such as in acrobatic shows. In these embodiments, the physical world elements 101 may include up to 100 or more acrobatic winches, underwater stage lifts, fountains, pyrotechnics, lighting and video. One embodiment of the control system may include NAVIGATOR™ automation system to provide the control one or more of the physical world elements.

Another embodiment according to the present disclosure includes park and parade control, for example, at amusement parks, including all major venues on-site and ride show control. In this embodiment, the experience platform system according to the present disclosure provides centralized control of venues and parades and adaptive scheduling to react in real-time to events by collecting information from the physical world elements and the virtual world elements to create the real-time adaptive schedule and control.

Another embodiment according to the present disclosure includes physical interactive experience control to mirror an accompanying virtual reality (VR) experience.

In this embodiment, the VR environment (i.e., virtual world element) is tied to one or more physical world elements controlled in real time by a control system, such as the NAVIGATOR™ automation system. For example, motors, display screens, lighting or other physical elements may be controlled in response to actions or cues occurring in the VR environment.

Another embodiment according to the present disclosure includes a combination of mechanics, VR and real-time content in an interactive ride experience. In this embodiment, VR content (i.e., virtual world element) is generated in real-time and provided to a user seated in a ride vehicle. Physical motion of the ride vehicle, through physical world elements, are controlled to synchronize motion to the content.

Another embodiment according to the present disclosure includes a ride-wide control, including the control of ride vehicles and interactive/immersive elements with adaptive scheduling for seamless ride variability. The system according to the present disclosure permits 1000's of immersive inputs and outputs, full integration with ride system and adaptive scheduling.

Another embodiment according to the present disclosure includes a venue that provides physical flying and atmospheric effects tied to VR having real-time control and variability. The system according to the present disclosure permits real-time bi-directional communication between VR (virtual world elements) and physical world elements, such as those controlled via the NAVIGATOR™ automation system, which may, for example provide atmospheric effects corresponding to the VR environment.

In this embodiment, physical world elements, such as video screens or displays may be integrated with cloud-based scheduling, content Another embodiment according to the present disclosure includes immersive shows with extensive integration between display/projection and crowd movement. In this embodiment, physical world elements, such as computer visions cameras, location tracking sensors or other systems for measuring crowd movement may be combined with reactive projection mapping resulting from virtual world elements, such as big data analysis, artificial intelligence, content profiles or other programmed elements.

Another embodiment according to the present disclosure includes scalable content management and scheduling profiles or other virtual world elements to provide individualized customization site-wide instantaneously and in real time.

Another embodiment according to the present disclosure includes staging and automation elements for live entertainment events, where physical world elements, such as staging elements and video elements, within the show experience are fully automated through the integrated experience platform system 100.

Another embodiment according to the present disclosure includes heat mapping and dwell time reporting via computer vision with integration utilizing RFID, Wifi with customize reporting (e.g., KPI reporting), for example, to provide crowd behavior monitoring to provide customized wayfinding and content management. Utilization of the experience platform system according to the present disclosure allows site-wide control with personalized wayfinding and crowd behavior monitoring to manage the venue. The experience platform system according to the present disclosure permits 3D visualization, personalization, site-wide control, content management, adaptive scheduling and guest portal interactions to enhance the guest experience. Likewise, the experience platform system according to the present disclosure allows for in-app personalization to provide a personalized experience to a guest's mobile device. The in-app personalization allows extensive intelligence and reporting features to enhance the guest experience and provide business intelligence for the venue.

Other features and advantages of the present invention will be apparent from the following more detailed description of the preferred embodiment, taken in conjunction with the accompanying drawings which illustrate, by way of example, the principles of the invention.

### BRIEF DESCRIPTION OF DRAWINGS

FIG. 1 schematically shows an embodiment of an experience platform system according to an embodiment of the present disclosure.

FIG. 2 schematically shows an alternate embodiment of an experience platform system according to an embodiment of the present disclosure.

FIG. 3 schematically shows an embodiment of a node from the experience platform system of FIG. 2.

FIG. 4 schematically shows an embodiment of an operator console node from the experience platform system of FIG. 2.

FIG. 5 illustrates a data processing system according to an embodiment of the present disclosure.

FIG. 6 schematically shows an embodiment of a sub-or co-process of a node process according to an embodiment of the present disclosure.

FIG. 7 schematically shows an embodiment of an experience platform system for the personalized of a guest at a theme park according to an embodiment of the present disclosure.

FIG. 8 schematically shows an embodiment of an experience platform system for content management according to an embodiment of the present disclosure.

FIG. 9 schematically shows an implementation of the experience platform system of FIG. 8 including content displays.

FIG. 10 schematically shows an embodiment of an experience platform system for crowd/individual behavior analysis and steering according to an embodiment of the present disclosure.

FIG. 11 schematically shows an embodiment of an experience platform system for personalize experience in a venue according to an embodiment of the present disclosure.

FIG. 12 schematically shows an implementation of the experience platform system of FIG. 11 including personalized room selection according to guest preference.

FIG. 13 schematically shows an implementation of the experience platform system of FIG. 11 including personalized experience selection within a venue according to guest preference.

FIG. 14 schematically shows an embodiment of an experience platform system for venue site-side control according to an embodiment of the present disclosure.

FIG. 15 schematically shows an embodiment of an experience platform system for wearable and motor control according to an embodiment of the present disclosure.

Wherever possible, the same reference numbers will be used throughout the drawings to represent the same parts.

### DETAILED DESCRIPTION OF THE INVENTION

The experience platform system includes embodiments having a system architecture providing an operating system for guest experiences. For example, the experience platform system may include customized experiences for guest, crowds or individuals that integrates the physical and digital worlds that are safe and secure, real-time, and scalable to engage the audiences in an individual manner.

The physical world, as utilized herein, includes sensory perception by a human of an event that occurs (e.g., visual, audio, environmental, motion). Virtual world, as utilized herein, includes information, data or sensory perception by a human of an event that doesn't occur in real-world, but may include effects that are signaled to the human for perception by another sensory input (e.g., audio/visual (A/V) to user alone). The virtual world, as utilized herein, is not limited to known virtual reality systems, but includes other virtual systems, such as virtual spaces and models, profile information and related data (e.g., inputs customized for each unique user (e.g., “personalization”)), simulations, physics/game engines, avatars and virtual representations, applications and computer programs, big data/large learning models and artificial intelligence (AI), such as generative AI, as well as augmented reality (AR), extended reality (XR) and mixed reality (MR).

In certain embodiments, the experience platform system combines show control, Building Management Systems (BMS,) and Content Management System (CMS) with personalization & operational flexibility without degrading the quality when the staff makes changes. Examples of areas in which the experience platform system may integrate physical and virtual elements to provide adaptive control, customization and personalization in experiential venues include, but are not limited to, access control, lighting control, shading/glazing, air handlers, alarm & security, ticketing, point of sale (POS), food and beverage (F & B), merchandise, parking, sponsorship/partnership reporting, machine learning, blockchain technology, augmented & mixed reality, wearables, staff planning & resource allocation, sports betting, e-sports, fantasy sports, broadcast solutions/OTT, and dashboards. Particularly suitable areas for use of the experience platform system includes, but is not limited to content management, crowd behavior, personalization, site-wide control, adaptive scheduling, guest portals, intelligence & reporting, 3D visualization engines, augmented reality (AR)/mixed reality (MR)/extended reality (XR) connectivity.

An advantage of embodiments of the present disclosure is that the system and method include improvements in various venue control and experiences. For example, the experience platform system provides improvement to the following:
Content Management: Content design, creation, scheduling, distribution and delivery to any quantity, size and format of digital canvas. Allows for wayfinding, branding and guest communication at scale.
Location Awareness: Monitor, react and influence individual and group movement.
Personalization: create personalized guest journeys and experiences on expressed preferences and guest behavior.
Site-Wide Control: Monitor sensors and environmental inputs and apply complex logic intelligence to control outputs accordingly.
Adaptive scheduling: Influence a guest's journey based on external data and requirements to provide unique and seamless variable guest routing and experiences.
Guest Portal: Accentuate and individualize the guest journey through wearable or handheld devices.
Intelligence & Reporting: Detailed and customizable analytics and metrics on finance, guest experience and behavior.
3D Visualization AR/XR: 3D immersive environmental models that enable the design, modeling, programming and diagnosing of mega scale projects.

In certain embodiments, the experience platform system may include the following benefits for various stakeholders:
Guests: A visit that always provides individualized experiences to guests in every area of the venue. With respect to shopping and purchasing, the system presents the right goods at the right time for the guest. The system provides repeatability, where the experience feels subtly new and updated each time the guest visits. Obstacles and frustrations of queuing are reduced through real-time location monitoring and wayfinding. In addition, these features improve customer service, for example, by permitting a guest to find the right staff members with the right answer all the time. The system provides a guest immersion into the experience making the venue feel part of the experience, not just the home of the experience.
Guests: Navigation through a venue may include real-time personalization, location awareness, and content delivery systems provide customized wayfinding for each guest.
Owners: Benefits for venue owner include extended duration of the guest stay in revenue generating areas of the venue. In addition, the system provides maximized access to guest sales opportunities. Real-time personalization, crowd behavior and content delivery systems provide data-driven metrics. Personalizing the experience results in increased return visits by the same guests. Owners are beneficially able to influence guest journeys to maximize venue capacity, guest experience and profitability. In addition, the system reduces operating costs by automating monitoring and notifications and consolidating show operations. The system is scalable and configurable to accommodate both simple systems with a few objects as well as complex systems with a multitude of objects.
Operators: The system permits activation and control of multiple venues in real-time. Site-wide control activates experiences from a central control room while adaptive scheduling provides real-time automated adaptation of show sequences. Real-time personalization, wayfinding and content delivery systems combine to spread guests more evenly around the venue.

An advantage of the present application is the distribution of the control processing load among several controllers that can reduce the processing power required of any one controller and enable more cost-effective controllers to be used.

Yet another advantage of the present application is that operators can configure the system's capabilities to satisfy their current needs but can expand the system capabilities as required.

A further advantage of the present application is the inclusion of specific capabilities and features associated with different areas, from theaters to theme parks to motion picture productions and stunts to cruise ships to airports. Other suitable areas for the inclusion of specific capabilities and features may include hotels, malls, city centers, worlds fairs or any other location where an elevated guest experience is desired.

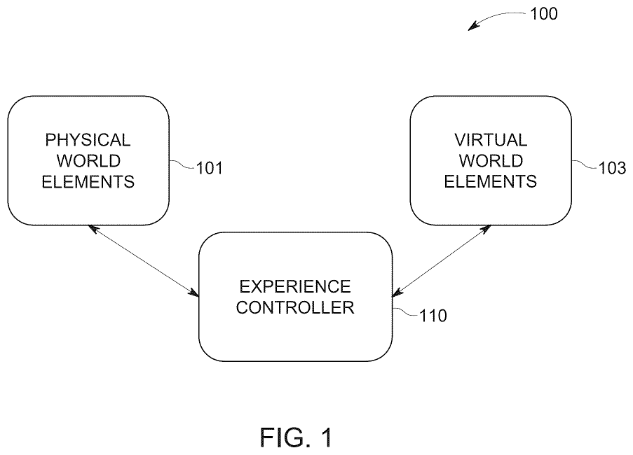

FIG. 1 shows an exemplary embodiment of the experience platform system 100 according to the present disclosure. The experience platform system 100 may include an experience controller 110 integrating physical world elements 101 and virtual world elements 103. Physical world elements, as utilized herein, include at least some tangible objects and real-life interactions with the real-world and include or have corresponding hardware and/or software that provide at least some level of control of the tangible objects. Physical world elements 101 may include operator consoles, remote stations, safety systems, machinery, input/output devices and external systems. For example, physical world elements 101 may include, but are not limited to lifts, chain hoists, winches, elevators, carousels, turntables, hydraulic systems, pneumatic systems, multi-axis systems, linear motion systems (e.g., deck tracks and line sets), audio devices, lighting devices, and/or video devices; input/output devices, such as incremental encoders, absolute encoders, variable voltage feedback devices, resistance feedback devices, tachometers and/or load cells; and external systems, such as show control systems, industrial protocols and third party software interfaces including 0-10 V (volt) systems, Modbus systems, Profibus systems, ArtNet systems, BMS (Building Management System) systems, EtherCat systems, DMX systems, SMPTE (Society of

Motion Picture and Television Engineers) systems, VITC systems, MIDI (Musical Instrument Digital Interface) systems, MANET (Mobile Ad hoc NETwork) systems, K-Bus systems, Serial systems (including RS 485 and RS 232), Ethernet systems, TCP/IP (Transmission Control Protocol/Internet Protocol) systems, UDP (User Datagram Protocol) systems, ControlNet systems, DeviceNet systems, RS 232 systems, RS 45 systems, CAN bus (Controller Area Network bus) systems, Maya systems, Lightwave systems, Catalyst systems, 3ds Max or 3D Studio Max systems, and/or a custom designed system. Particularly suitable physical world elements 101 may include, for example, motors/drivers, cameras/computer vision (CV), sensors, lighting elements, sound/acoustic elements, pyrotechnic elements, video screens, point of sale systems, mobile devices/cell phones, and wearables, such as VR/AR/XR headsets. Other physical world elements may include, for example, objects, features or equipment moved by some of the devices noted above, such as floors, ceilings, walls, objects within a space or other physical elements that can be moved by automation/automated systems. Virtual world elements, as utilized herein, include elements, such as code or data, that are intangible and/or simulated and reside in the memory of one or more computer system. One embodiment of the control system may include NAVIGATOR™ automation system to provide the control one or more of the physical world elements. NAVIGATOR™ automation systems may include, for example, systems such as those disclosed in U.S. Pat. No. 8,768,492, entitled AUTOMATION AND MOTION CONTROL SYSTEM, which is hereby incorporated by reference in its entirety. Virtual world elements 103 may include models of objects, systems or features that also exist in the physical world or may be models of things that don't exist in the physical world and are entirely virtual. Virtual world elements 103 may include, for example, user profiles, virtual spaces/models, simulators, physics/game engines, avatars, applications, and big data/artificial intelligence (AI). Other examples of virtual world elements 103 include, but are not limited to virtual spaces and models, profile information and related data (e.g., guest journeys, user preferences or other personalized guest information), simulations, physics/game engines, avatars and virtual representations, applications and computer programs, big data/large learning models and artificial intelligence (AI), such as generative AI. The experience controller 110 may include hardware or software having the ability to communicate and/or transmit signals, data, information or code between physical world elements 101 and virtual world elements in order to provide integrated control of a physical world element 101. In one embodiment, the experience controller 110 includes an arrangement of hardware and/or software that provides real-time control of a physical world element 101. For example, in one embodiment, a user may wear an augmented reality (AR) headset allowing the user to see elements of the real world, while simultaneously perceiving a unique experience based on projections through the AR headset resulting from a virtual world model, providing a mix of virtual world elements 103 and physical world elements 101.

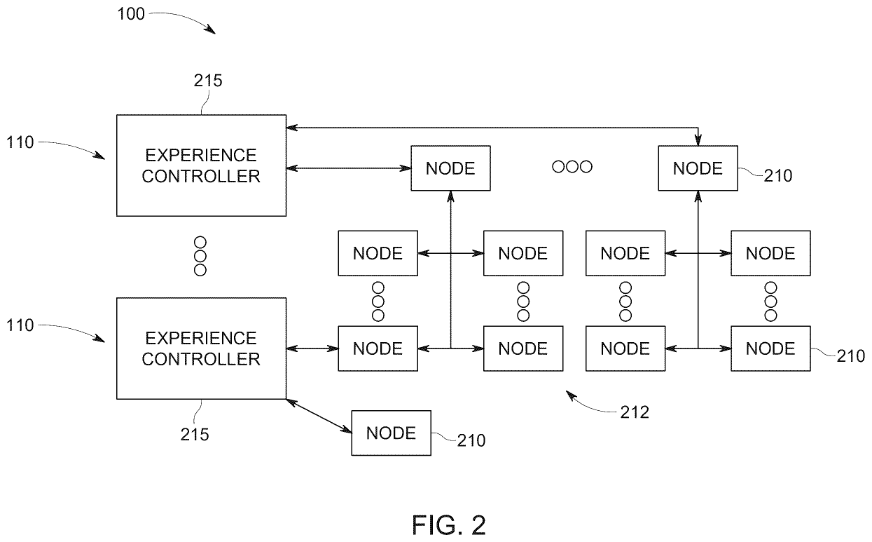

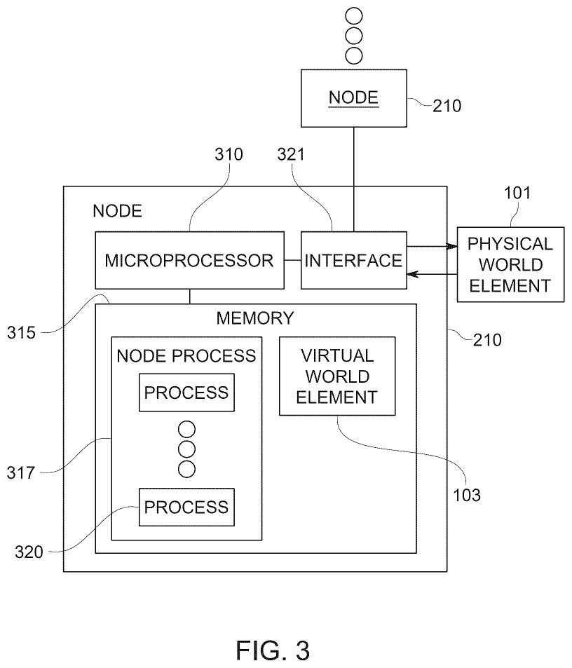

FIG. 2 shows an embodiment of the experience platform system 100 according to the present disclosure. The experience platform system 100 shown in FIG. 2 may be formed from the interconnection of nodes 210. Each node 210 may correspond to a physical world element 101, a virtual world element 103 or both (see for example FIG. 3). By “correspond to”, “corresponding to” and grammatical variations thereof, it is meant that the node 210 includes a microprocessor and associated software/firmware that controls or otherwise interacts with the physical world element 101 and/or virtual world element 103 in a manner that provides control, data or information exchange. The experience controller 110 may be an operator console node 215 (e.g., a node having certain additional interface and/or control properties) and may in itself correspond to a physical world element 101 and/or a virtual world element 103. In one exemplary embodiment, the experience controller 110 may may include a computer and/or computer system. The experience controller 110 may enable an operator to interact with the experience platform system 100, i.e., to send data and instructions to the various elements of the experience platform system 100 and to receive data and information from the various elements of the experience platform system 100. In this embodiment, the experience controller 110 may be similar to the other nodes 210 except that the experience controller 110 may further include a graphical user interface (GUI) or human-machine interface (HMI) to enable the operator to interact with the experience platform system 100. For example, in one exemplary embodiment, the operator(s) may make inputs into the system experience controller 110 using one or more input devices, e.g., a pointing device such as a mouse, a keyboard, a panel of buttons, or other similar devices. While FIG. 2 shows the arrangement of nodes 210 including an experience controller 110 as an operator console node 215, the experience controller 110 is not so limited and may include other configurations and arrangements wherein the experience controller 110 provides connection between the physical world element 101 and the virtual world element 103.

As shown in FIG. 2, nodes 210 and experience controller 110 are interconnected with each other. Thus, nodes 210, 215 may communicate, i.e., send and receive data and/or instructions, with any other node 210, 215 in the experience platform system 100. In one exemplary embodiment, a group of nodes 210 may be arranged or configured into a network 212 that interconnects the nodes 210 in the group and provides a reduced number of connections with the other nodes 210, 215. In another exemplary embodiment, nodes 210, 215 and/or node networks 212 may be interconnected in a star, daisy chain, ring, mesh, daisy chain loop, token ring, or token star arrangement or in combinations of those arrangements. In a further exemplary embodiment, the experience platform system 100 may be formed from more or less nodes 210, 215 and/or node networks 212 than those shown in FIG. 2.

In one exemplary embodiment, each node 210, 215 may be independently operated and self-aware, and may also be aware of at least one other node 210, 215. In other words, each node 210, 215 may be aware that at least one other node 210, 215 is active or inactive (e.g., online or offline).

In another exemplary embodiment, each node 210, 215 is independently operated using decentralized processing, thereby allowing the experience platform system 100 to remain operational even if a node 210, 215 may fail because the other operational nodes still have access to the operational data of the nodes. Each node 210, 215 may be a current connection into the experience platform system 100, and may have multiple socket connections into the network, each providing node communications into the control system through the corresponding node 210, 215. As such, as each individual node 210, 215 is taken “offline,” the remaining nodes 210, 215 may continue operating and load share. In a further exemplary embodiment, the control system may provide the operational data for each node to every other node 210, 215 all the time, regardless of how each node 210, 215 is related to each other node 210, 215.

FIG. 3 schematically shows an exemplary embodiment of a node 210. Each node 210 includes a microprocessor 310 and a memory device 315. The memory device 315 may include or store a main or node process 317 that may include one or more sub-or co-processes 320 that are executable by the microprocessor 310. The main or node process 317 provides the networking and hardware interfacing to enable the sub-or co-processes 320 to operate. As shown in FIG. 3, a physical world element 101 may be in communication with node 210 to allow the passage of signals, data and/or instructions to and from the physical world element 101. As shown in the embodiment shown in FIG. 3, while not so limited, signals, data and/or instructions to and from the physical world element 101 may be connected to node 210 by interface 321. Interface 321 may be any suitable electronic interface known for connecting devices or components to computer systems. The signals, data and/or instructions to and from the physical world element 101 may be dynamic information related to the physical world element 101 that is processed by microprocessor 310 or may be signals, data and/or instructions transmitted to other nodes 210 or to the operator console node 215. As shown in FIG. 3, node 210 may include a virtual world element 103 that is integrated into memory device 315. Although FIG. 3 shows a virtual world element 103, the presence of virtual world element 103 may be optional, particularly when node 210 corresponds to physical world element 101. While node 210 of FIG. 3 includes both a physical world element 101 and a virtual world element 103, in other embodiments node 210 may include either a physical world element 101 or a virtual world element 103. The transfer of information may include dynamic or real-time information and the node 210 may gather or receive real-time or dynamic data to be stored at node 210 and/or transmitted to other nodes 210 or the operator console node 215.

In one embodiment, physical world elements 101 may include sensors for data collecting. In certain embodiments, sensors may provide sensing or indication useful for determining a state or property of a physical world element 101 corresponding to node 210. Some examples of dynamic or real-time information that may be measured with sensors may include temperature, current, load or weight (load cell), position, angle, g-force or acceleration (accelerometer), direction of movement, or speed of movement. Suitable sensors may include, but are not limited to inertia sensor (e.g., accelerometers, gyro-sensors, etc.), global positioning system (GPS) sensors, voltage meters, temperature sensors, contact or non-contact displacement sensors (e.g., linear variable differential transformers (LVDT), differential variable reluctance transducers (DVRT)), slide potentiometers, radar sensors, LiDAR sensors, magnetic sensing systems, optical or infrared sensing systems, radio frequency identification (RFID) sensors, computer vision (CV) or any combination thereof. For example, while not so limited, the data from these sensors may be utilized for crowd analysis, individual location identification or behavior analysis. Other conditions may also be sensed with sensors, such as humidity, temperature, odors/chemicals or other environmental conditions that may affect a particular venue or experience.

The microprocessor 310 in a node 210 may operate independently of the other microprocessors 310 in other nodes 210. The independent microprocessor 310 enables each node 210 in the experience platform system 100 to operate or function as a “stand-alone” device or as a part of a larger network. In one exemplary embodiment, when the nodes 210 are operating or functioning as part of a network, the nodes 210 may exchange information, data and computing power in real time without recognizing boundaries between the microprocessors 310 to enable the experience platform system 100 to operate as a “single computer.” In another embodiment, each node 210 may use an embedded motion controller.

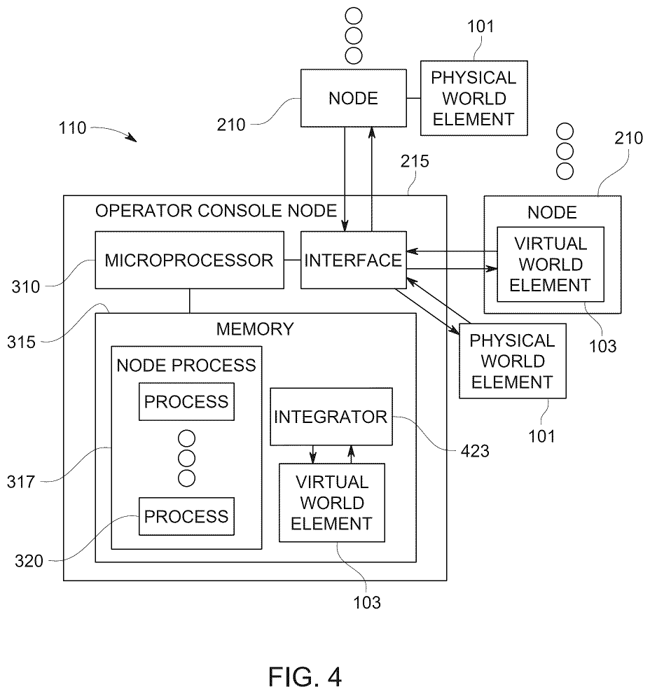

FIG. 4 schematically shows an exemplary embodiment of an experience controller 110 according to an embodiment of the present disclosure. In the embodiment shown in FIG. 4, the experience controller 110 includes an operator console node 215. Each operator console node 215, like node 210, includes a microprocessor 310 and a memory device 315. The memory device 315 may include or store a main or node process 317 that may include one or more sub-or co-processes 320 that are executable by the microprocessor 310. The main or node process 317 provides the networking and hardware interfacing to enable the sub-or co-processes 320 to operate. In addition to the node process 317, memory device 315 includes integrator 423. In these embodiments, the experience controller 110 includes an integrator 423 to provide interaction between the physical world elements 101 with the virtual world elements 103 (see, for example, FIG. 4) resulting in an output for control of physical world elements 101 and/or virtual world elements 103. As shown in FIG. 4, a physical world element 101 may be in communication with operator console node 215 to allow the passage of signals, data and/or instructions to and from the physical world element 101. In addition, operator console node 215 may be in communication with a node 210, such as the node shown in FIG. 3, that is in communication with a physical world element 101. Node 210 or the physical world element 101 may be connected to the operator console node 215 by interface 321. The signals, data and/or instructions to and from the physical world element 101 may be dynamic information related to the physical world element 101 that is processed by microprocessor 310 or may be signals, data and/or instructions transmitted to other nodes 210 or to the operator console node 215. As shown in FIG. 4, operator console node 215 may include a virtual world element 103 that is integrated into memory device 315. In addition, a connected node 210 may include a virtual world element 103, which includes signals, data and/or instructions to and from the virtual world element 103 in node 210 to operator console node 215. Although FIG. 4 shows virtual world elements 103 integrated into the operator console node 215 and in node 210 connected to operator console node 215, these are not both required. One or both of the locations of virtual world elements 103 may be provided. Likewise, while operator console node 215 of FIG. 4 includes both a physical world element 101 directly connected to the operator console node 215 and a physical world element 101 connected to a node 210, which is connected to the operator console node 215, both are not required. One or both of the location of physical world elements 101 may be provided.

Integrator 423 of operator console node 215 receives signals, data and/or instructions from both physical world elements 101 and virtual world elements 103 and provides an output set of signals, data and/or instructions that communicated back to one or both of the physical world elements 101 and the virtual world elements 103 to provide an integrated response that provides a connection and relationship between the physical world element 101 and the virtual world element 103. The integrator 423 may be code, information, instructions or data or may include code, information, instructions or data that is arranged and configured to collect inputs from the physical world element(s) 101 and virtual world element(s) 103 and generate smart outputs to the physical world element(s) 101 based upon the inputs collected. The integrator 423 includes primitive and abstracted goals that may be programmed into the integrator 423 or provided by a user and utilizes these goals to generate the smart outputs based upon these goals and the real-time inputs from the physical world element(s) 101 and the virtual world element(s) 103. That is, the integrator 423 works within the experience platform system 100 to collect these bespoke systems and data together as inputs to make smart, predictive decisions about what all of the outputs do. The primitive and abstracted goals provide basic guidance to the integrator 423 to allow a user to provide a high-level control and/or some direction and/or theme to the predictive decisions and control outputted by the integrator to the physical world elements 101. For example, the integrator 423 may use artificial intelligence, big data or other computing systems to integrate the inputs based on the primitive and abstracted goals to generate the predictive outputs in real time. The experience platform system 100 integrates the real-time inputs from the physical world element(s) 101 and the virtual world element(s) 103 significantly faster than humans could do. The ultimate effect of utilizing the integrator 423 is that experiences may effectively emulate having a guide or VIP experience for every single guest, helping optimize every system around them.

While not so limited, the integration of the physical world element 101 and the virtual world element 103 may include providing one or more features selected from the group consisting of individual wayfinding in a venue, individual content management of a venue system, individual content management of a customer interface, crowd behavior analysis and steering, site-wide control and combinations thereof.

The microprocessor 310 in an operator console node 215 may operate independently of the other microprocessors 310 in other an operator console nodes 215. The independent microprocessor 310 enables each operator console node 215 in the experience platform system 100 to operate or function as a “stand-alone” device or as a part of a larger network. In one exemplary embodiment, when the operator console nodes 215 is operating or functioning as part of a network, the operator console nodes 215 may exchange information, data and computing power in real time without recognizing boundaries between the microprocessors 310 to enable the experience platform system 100 to operate as a “single computer.”

In one example, the virtual world element 103 from the memory device 315 of the operator console node 215 or the virtual world element 103 corresponding to a connected node 210 may be a representation of a controlled device. For example, the represented device may be a physical world element 101, such as a lift, chain hoist, winch, elevator, carousel, turntable, hydraulic system, pneumatic system, multi-axis system, linear motion system, audio device, lighting device, or video device. The virtual world element 103 including this representation may be a 3-dimensionsal (3-D) model of the device. The representation may include information regarding the capabilities of device that may be utilized in calculations, algorithms or control schemes to control devices. The integrator 423 may gather information from physical world elements 101, which may include the device represented in the virtual world element 103. That is, the integrator may dynamically obtain data relating to the device, including the device's physical configuration and/or properties, from physical sources, such as from sensors corresponding to the device. The data obtained by the integrator 423 may be communicated to or combined with information from the virtual world element 103 to provide an updated 3-dimensional model of the device which may be displayed on, for example, a graphical user interface (GUI) or human-machine interface (HMI) to provide real time information about the device. In addition to displaying the information in the GUI, the experience platform system 100 processes and provides instructions to the physical world elements 103 on what those elements should be doing. By providing the processing in real-time, every input change to the integrator 423 effectively triggers all outputs (i.e., control of the physical world elements 103) to reconsider what they should and to provide the adjusted control of that element.

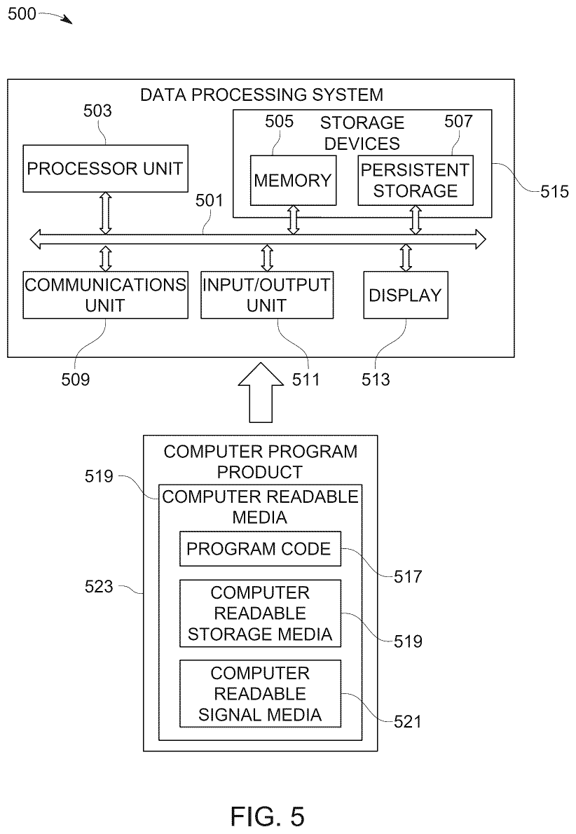

FIG. 5 shows an exemplary illustration of a data processing system 500 suitable for use as components of the system, including, but not limited to node 210 and experience controller 110. In this illustrative example, data processing system 500 may include communications fabric 501, which provides communications between processor unit 503, memory 505, persistent storage 507, communications unit 509, input/output (1/0) unit 511 and display 513. While FIG. 5 shows various elements including processor unit 503, memory 505, persistent storage 507, communications unit 509, input/output (I/O) unit 511, and display 513, some or all of the elements may be present for particular configurations of node 210 and/or experience controller 110. For example, certain nodes may not utilize input/output (I/O) unit 511 and display 513. The utilization or particular components is dependent upon the functionality needed for a particular node 210 or experience controller 110.

Processor unit 503 may be one or a number of processors, a multi-processor core, or some other type of processor, depending on the particular implementation. A number, as used herein with reference to an item, means one or more items. Further, processor unit 503 may be implemented using a number of heterogeneous processor systems in which a main processor is present with secondary processors on a single chip. As another illustrative example, processor unit 503 may be a symmetric multi-processor system containing multiple processors of the same type.

Memory 505 and persistent storage 507 are examples of storage devices 515. A storage device is any piece of hardware that is capable of storing information, such as, for example, without limitation, data, program code in functional form, and/or other suitable information either on a temporary basis and/or a permanent basis. Storage devices 515 may also be referred to as computer readable storage devices in these examples. Memory 505, in these examples, may be, for example, a random access memory or any other suitable volatile or non-volatile storage device. Persistent storage 507 may take various forms, depending on the particular implementation.

For example, persistent storage 507 may contain one or more components or devices. For example, persistent storage 507 may be a hard drive, a flash memory, a rewritable optical disk, a rewritable magnetic tape, or some combination of the above. The media used by persistent storage 507 also may be removable. For example, a removable hard drive may be used for persistent storage 507.

Communications unit 509, in these examples, provides for communications with other data processing systems or devices. In these examples, communications unit 509 is a network interface card. Communications unit 509 may provide communications through the use of either or both physical and wireless communications links.

Input/output (I/O) unit 511 allows for input and output of data with other devices that may be connected to data processing system 500. For example, input/output (I/O) unit 511 may provide a connection for user input through a keyboard, a mouse, and/or some other suitable input device. Further, input/output (I/O) unit 511 may send output to a printer. Display 513 provides a mechanism to display information to a user.

Instructions for the operating system, applications, and/or programs may be located in storage devices 515, which are in communication with processor unit 503 through communications fabric 501. In these illustrative examples, the instructions are in a functional form on persistent storage 507. These instructions may be loaded into memory 505 for execution by processor unit 503. The processes of the different embodiments may be performed by processor unit 503 using computer implemented instructions, which may be located in a memory, such as memory 505.

These instructions are referred to as program code 517, computer usable program code, or computer readable program code that may be read and executed by a processor in processor unit 503. The program code 517 in the different embodiments may be embodied on different physical or computer readable storage media, such as memory 505 or persistent storage 507.

Program code 517 is located in a functional form on computer readable storage media 519 that is selectively removable and may be loaded onto or transferred to data processing system 500 for execution by processor unit 503. Program code 517 and computer readable storage media 519 form computer program product 523 in these examples. In one example, computer readable storage media 519 may be computer readable storage media 519 or computer readable signal media 521. Computer readable storage media 519 may include, for example, an optical or magnetic disk that is inserted or placed into a drive or other device that is part of persistent storage 507 for transfer onto a storage device 515, such as a hard drive, that is part of persistent storage 507. Computer readable storage media 519 also may take the form of a persistent storage 507, such as a hard drive, a thumb drive, or a flash memory, that is connected to data processing system 500. In some instances, computer readable storage media 519 may not be removable from data processing system 500.

Alternatively, program code 517 may be transferred to data processing system 500 using computer readable signal media 521. Computer readable signal media 521 may be, for example, a propagated data signal containing program code 517. For example, computer readable signal media 521 may be an electromagnetic signal, an optical signal, and/or any other suitable type of signal. These signals may be transmitted over communications links, such as wireless communications links, optical fiber cable, coaxial cable, a wire, and/or any other suitable type of communications link. In other words, the communications link and/or the connection may be physical or wireless in the illustrative examples.

In some illustrative embodiments, program code 517 may be downloaded over a network to persistent storage 507 from another device or data processing system through computer readable signal media 521 for use within data processing system 500. For instance, program code 517 stored in a computer readable storage medium in a server data processing system may be downloaded over a network from the server to data processing system 500. The data processing system providing program code 517 may be a server computer, a client computer, or some other device capable of storing and transmitting program code 517.

The different components illustrated for data processing system 500 are not meant to provide architectural limitations to the manner in which different embodiments may be implemented. The different illustrative embodiments may be implemented in a data processing system 500 including components in addition to or in place of those illustrated for data processing system 500. Other components shown in FIG. 5 can be varied from the illustrative examples shown. The different embodiments may be implemented using any hardware device or system capable of running program code 517. As one example, the data processing system 500 may include organic components integrated with inorganic components and/or may be comprised entirely of organic components excluding a human being. For example, a storage device may be comprised of an organic semiconductor.

In another illustrative example, processor unit 503 may take the form of a hardware unit that has circuits that are manufactured or configured for a particular use. This type of hardware may perform operations without needing program code to be loaded into a memory from a storage device to be configured to perform the operations.

For example, when processor unit 503 takes the form of a hardware unit, processor unit 503 may be a circuit system, an application specific integrated circuit (ASIC), a programmable logic device, or some other suitable type of hardware configured to perform a number of operations. With a programmable logic device, the device is configured to perform the number of operations. The device may be reconfigured at a later time or may be permanently configured to perform the number of operations. Examples of programmable logic devices include, for example, a programmable logic array, programmable array logic, a field programmable logic array, a field programmable gate array, and other suitable hardware devices. With this type of implementation, program code 517 may be omitted because the processes for the different embodiments are implemented in a hardware unit.

In still another illustrative example, processor unit 503 may be implemented using a combination of processors found in computers and hardware units. Processor unit 503 may have a number of hardware units and a number of processors that are configured to run program code 517. With this depicted example, some of the processes may be implemented in the number of hardware units, while other processes may be implemented in the number of processors.

The different illustrative embodiments can take the form of an entirely hardware embodiment, an entirely software embodiment, or an embodiment containing both hardware and software elements. Some embodiments are implemented in software, which includes but is not limited to forms such as, for example, firmware, resident software, and microcode.

Furthermore, the different embodiments can take the form of a computer program product accessible from a computer usable or computer readable medium providing program code for use by or in connection with a computer or any device or system that executes instructions. For the purposes of this disclosure, a computer usable or computer readable medium can generally be any tangible apparatus that can contain, store, communicate, propagate, or transport the program for use by or in connection with the instruction execution system, apparatus, or device.

The computer usable or computer readable medium can be, for example, without limitation an electronic, magnetic, optical, electromagnetic, infrared, or semiconductor system, or a propagation medium. Non-limiting examples of a computer readable medium include a semiconductor or solid-state memory, magnetic tape, a removable computer diskette, a random access memory (RAM), a read-only memory (ROM), a rigid magnetic disk, and an optical disk. Optical disks may include compact disk-read only memory (CD-ROM), compact disk-read/write (CD-R/W), and DVD.

Further, a computer usable or computer readable medium may contain or store a computer readable or computer usable program code such that when the computer readable or computer usable program code is executed on a computer, the execution of this computer readable or computer usable program code causes the computer to transmit another computer readable or computer usable program code over a communications link. This communications link may use a medium that is, for example, without limitation, physical or wireless.

The data processing system 500 is suitable for storing and/or executing computer readable or computer usable program code 517 will include one or more processors coupled directly or indirectly to memory elements through a communications fabric, such as a system bus. The memory elements may include local memory employed during actual execution of the program code 517, bulk storage, and cache memories which provide temporary storage of at least some computer readable or computer usable program code to reduce the number of times code may be retrieved from bulk storage during execution of the code.

Input/output or I/O devices can be coupled to the system either directly or through intervening I/O controllers. These devices may include, for example, without limitation, keyboards, touch screen displays, and pointing devices. Different communications adapters may also be coupled to the system to enable the data processing system to become coupled to other data processing systems or remote printers or storage devices through intervening private or public networks. Non-limiting examples of modems and network adapters are just a few of the currently available types of communications adapters.

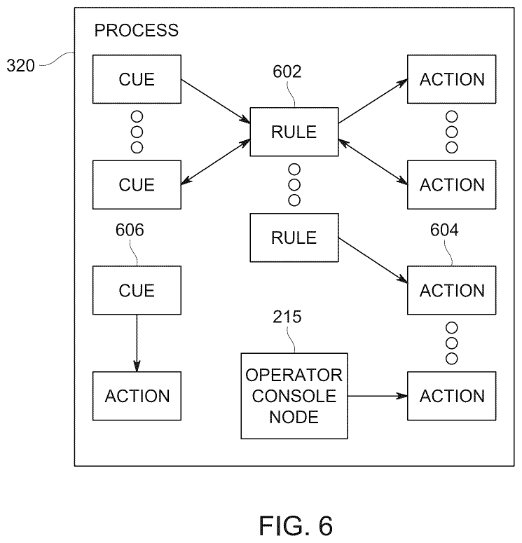

FIG. 6 schematically shows an exemplary embodiment of a sub-or co-process for node 210, 215. Each sub-or co-process 320 includes one or more actions 604 that may be triggered by one or more rules 602 and/or one or more cues 606 or by a direct command from an operator console node 215. In another embodiment, one or more cues 606 may trigger one or more rules 602 or one or more actions 604 may trigger one or more rules 602. For example, one or more rules 602 may initiate one or more actions 604 in response to one or more cues 606.

In one exemplary embodiment, each rule 602 may be an if-then or an and-or statement or other similar type of case or logic statement. The cues 606 may be associated with the “if” conditions of the rule and may include measured parameters, e.g., velocities, accelerations, positions, voltages, currents, etc., and logic inputs, e.g., “1s” or “0s,” from other nodes or devices. The actions 604 may be associated with the “then” portion of the rule and may include controlling an operating speed of the machine(s) associated with the node or device, sending messages or commands to other nodes or devices, changing operational status, e.g., on or off, of system components, e.g., lights, relays or switches.

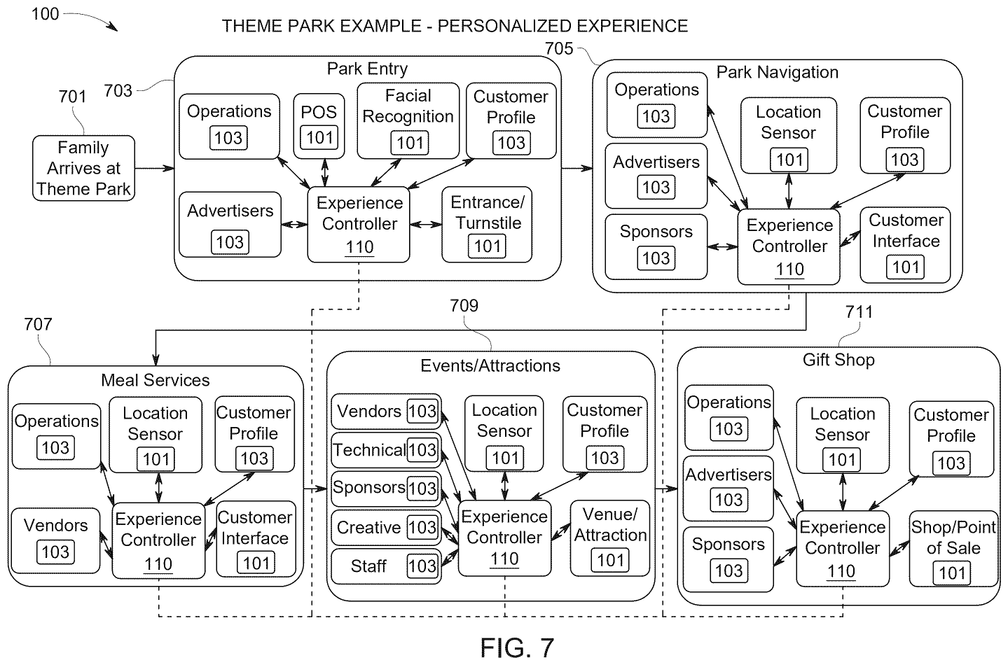

FIG. 7 shows an exemplary system arrangement of an experience platform system 100 according to the present disclosure utilizing an experience controller 110 integrating various physical world elements 101 and virtual world elements 103. FIG. 7 shows a customized theme park experience for a family visiting a theme park/entertainment venue. As shown in FIG. 7, a family arrives at a theme park, subsystem 701. Upon approaching the theme park entrance, subsystem 703, the guest interacts with various physical world elements 101 where virtual world elements 103 are integrated therewith to provide control of the entrance features (e.g., entrance turnstiles). For example, the park entry includes facial recognition and/or point of sale as physical world elements 101. Data, signals and/or information from these physical world elements 101 are integrated with virtual world elements 103 from operations, advertisers, customer profiles to provide a desirable customer experience during the park entry. For example, the data/profiles from operations, advertisers and the customer profile may include verifications of tickets, images of merchandise that would be of interest to the guest and/or may include individual preferences or attributes. The integration provides signals, information and/or control to the entrance/Turnstile to admit the guest to the theme park. The experience platform system 100 provides quick and efficient entry into the theme park, capacity management and provides and utilizes demographics and preferences useful for advertisers.

Once admitted to the theme park, the guest experience continues with park navigation, subsystem 705. Like park entry, subsystem 703 above, the guest interacts with various physical world elements 101 where virtual world elements 103 are integrated therewith to provide navigation information to and/or control of a customer interface (e.g., a mobile device, such as a smart watch, phone, tablet or wearable device). For example, the park navigation may utilize location sensors that are physical world elements 101 to determine the location of the guest. Data, signals and/or information from these physical world elements 101 are integrated with virtual world elements 103 from operations, advertisers, sponsors, and customer profiles to provide a desirable customer experience to assist the guest with navigation through the theme park. For example, the data/profiles from operations, advertisers and sponsors may include virtual models, instructions and/or content that may utilize information from other physical world elements 101 (e.g., the guest location) and the customer profile (e.g., personal preferences and/or demographics) to integrate these elements with the experience controller 110 to provide an output to a physical world element 101 (i.e., the customer interface). The output may include, for example, customized directions to attractions predicted as the guest's preference, images of merchandise that would be of interest to the guest and/or may include suggested options for the particular guest. The experience platform system 100 provides personalized directions based on guest profiles and preferences, focused deployment of staff or resources useful for the theme park operations and provides information to sponsors (e.g., guest dwell time) useful to deliver merchandise and/or advertising messages.

As shown in FIG. 7, the guest experience continues with meal services, subsystem 707. Like park navigation, subsystem 705 above, the guest interacts with various physical world elements 101 where virtual world elements 103 are integrated therewith to provide information to and/or control of a customer interface (e.g., a mobile device, such as phone or tablet). For example, meal services may utilize location sensors that are physical world elements 101 to determine the location of the guest. Data, signals and/or information from these physical world elements 101 are integrated with virtual world elements 103 from operations, vendors, and customer profiles to provide a desirable customer experience to assist the guest with identifying, navigating to, and obtaining meal services. For example, the data/profiles from operations and vendors may include virtual models, instructions and/or content that may utilize information from other physical world elements 101 (e.g., the guest location) and the customer profile (e.g., preferences for particular food) and/or allow the guest to order food (e.g., sent orders to the kitchen staff for preparation) to integrate these elements with the experience controller 110 to provide an output to a physical world element 101 (i.e., the customer interface). The output may include, for example, filtered menu choices, (e.g., gluten free, vegan or vegetarian options), customized directions and distances to locations that match their preferences, images of meal vendors or food items, and/or advertisements for particular meals or merchandise. The experience platform system 100 also provides information and data about the guests and the meal venues that are useful for vendors to maintain supplies. In addition, the system may include focused deployment of staff or resources useful for the cleaning and meal service operations.

As shown in FIG. 7, the guests also experience events/attractions, subsystem 709. Like park entry, subsystem 703 above, the guest interacts with various physical world elements 101 where virtual world elements 103 are integrated therewith to provide information and/or control of a venue/attraction (e.g., a parade, show or amusement ride). For example, events/attractions may utilize location sensors that are physical world elements 101 to determine the location of the guest. Data, signals and/or information from these physical world elements 101 are integrated with virtual world elements 103 from vendors, technical personnel, sponsors, creative personnel, operations and customer profiles to provide a desirable customer experience to maximize the enjoyment for the guest experience for events/attractions. For example, the data/profiles from vendors, technical personnel, sponsors, creative personnel, operations may include virtual models, instructions and/or content that may utilize information from other physical world elements 101 (e.g., the guest location) and the customer profile (e.g., preferences for particular attractions) to integrate these elements with the experience controller 110 to provide an output to a physical world element 101 (i.e., the customer interface). The output to the venue/attraction may include, for example, customized directions to provide customized information to the guest, proximity to particular attractions (e.g., proximity to favorite characters), real time photos, minimize queuing with adaptive schedules, information on next ride, and providing unique ride experiences. The experience platform system 100 may provide a wide variety of control for the venue or attraction including crowd control/queuing, control of the attraction or event (e.g., attraction overall control, ride vehicle control/experience or parade float control), or display personalized or customized content related to a particular guest. In addition, vendors may find opportunities for food and beverage and/or merchandise sales, as well as ecommerce and ordering capabilities and operations may have the ability to have adaptive control for attractions or events that may adapt physical control and/or content in real-time to an audience profile/preference as well as providing load balance queuing, maximized ride utilization, staffing and personalized assistance to guests who need assistance.

As shown in FIG. 7, an important revenue component to the operation of the theme park, is the guest experience with respect to purchasing merchandise at the gift shop, subsystem 711. While this embodiment is described as a gift shop, this system may be useful or any type of sales taking place in the theme park, including mobile sales, kiosks, roving employees, etc. Like park entry, subsystem 703 above, the guest interacts with various physical world elements 101 where virtual world elements 103 are integrated therewith to provide an integrated sale experience for the guest, operations, advertisers and sponsors. For example, this system may utilize location sensors that are physical world elements 101 to determine the location of the guest.

Data, signals and/or information from these physical world elements 101 are integrated with virtual world elements 103 from operations, advertisers, sponsors and customer profiles to provide a desirable guest experience in the sales process and to maximize the efficiency of operations, while maximizing sales and profit. For example, the data/profiles from operations, advertisers, sponsors may include virtual models, instructions and/or content that may utilize information from other physical world elements 101 (e.g., the guest location) and the customer profile (e.g., preferences for particular attractions) to integrate these elements with the experience controller 110 to provide an output to a physical world element 101 (i.e., the customer interface). The output to the shop/point of sale may include personalized or customize information about the guest, streamlining the purchasing process, decreasing the cost and time required to accomplish individual sales. In other embodiments, predictive or adaptive delivery of goods could be provided in response to guest preferences, guest demographics/information and location data. In addition, the output to the shop/point of sale may include personalized mementos, restocking instructions, and personalized content (e.g., guest preference information/payment information). In addition, sponsors and advertisers may find optimized opportunities for merchandise sales and advertisement. Operations may have the ability to provide appropriate staffing, crowd control and real-time adaptive theming (e.g., displayed content and/or lighting) in response to crowd demographics and preferences.

While subsystems 703, 705, 707, 709 and 711 are shown as being individual systems, as shown by connections in broken lines, the individual experience controllers 110 may communicate with each other or may be incorporated into a single experience controller. As discussed above with respect to FIGS. 2-4, the individual physical world elements 101 and virtual world elements 103 may be or may correspond to a node 210 of a network of nodes 210. Likewise, in certain embodiments, the experience controller 110, as well as certain physical world elements 101 and virtual world elements 103 may include an operator console node 215, as shown and described in FIG. 4 above. The interaction between the subsystems 703, 705, 707, 709 and 711 permits integrated site-wide control of the experience for the individual guest.

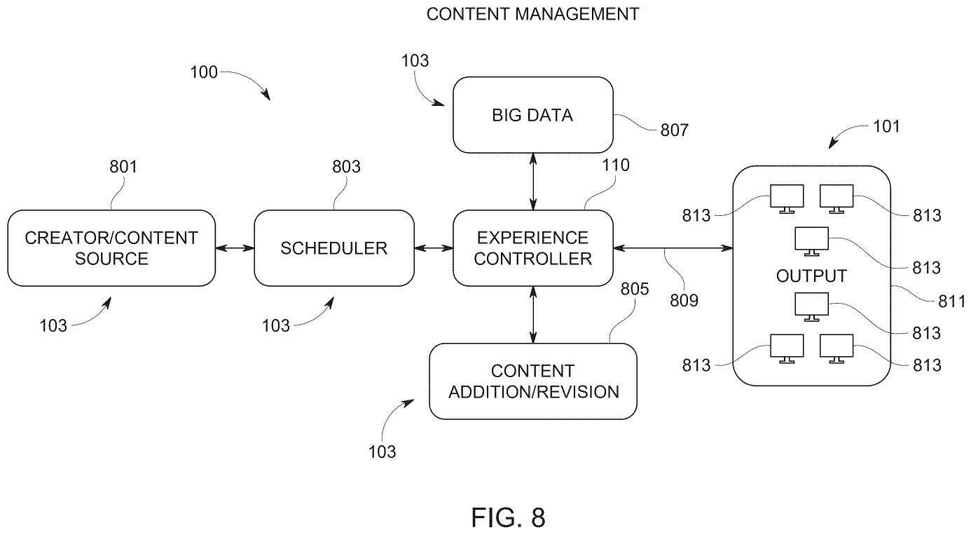

FIG. 8 shows a schematic view of an exemplary embodiment of an experience platform system 100 according to the present disclosure for content management for a cruise experience on a cruise ship. As shown in this embodiment, a creator designs a theme, for example for a particular cruise or cruise ship, from anywhere in the world. The resultant creator/content source 801 is transmitted to a scheduler 803. The scheduler 803 provides the creator/content source 801 to the cruise ship or the cruise fleet, as desired. As shown in FIG. 8, providing the creator/content source 801 includes transmitting the content to the experience controller 110. Additional information is provided by cruise staff in the form of content addition/revision 805, which is likewise transmitted to the experience controller 110. The experience controller 110 utilizes the virtual world element 103 of big data 807 to integrate the creator/content source 801 and content addition/revision 805 to provide personalization and data analysis for passenger experiences. The experience controller 110 outputs the integrated content data 809 from the integration of the creator/content source 801, the content addition/revision 805 and big data 807 to output 811. In this embodiment, output 811 may be hundreds or thousands of video displays throughout a multitude of ships across an entire fleet. As shown in FIG. 8, the creator/content source 801, content addition/revision 805 and big data 807 represents virtual world elements 101 that reside as data in the memory of one or more computers. The output 811 includes physical world elements 101 that are controlled to provide viewable displays 813 incorporating the integrated content data 809.

Big data, as utilized herein, includes large, complex datasets that are generally too large for traditional data processing tools and techniques to handle efficiently. In the context of data analysis, big data typically involves the collection, storage, processing, and analysis of massive amounts of structured, semi-structured, and unstructured data from a variety of sources. The analysis of big data aims to uncover patterns, trends, and insights that can drive decision-making, predictions, and innovations, including customization and personalization taking into account, for example, profiles of individuals participating in an entertainment experience. Advanced analytical techniques, such as machine learning, artificial intelligence, and statistical models, may be employed to identify correlations, predict future trends, and optimize processes. Machine learning, AI, statistical models, etc., used to analyze big data may be used as inputs to the experience controller 110 for analysis and integration.

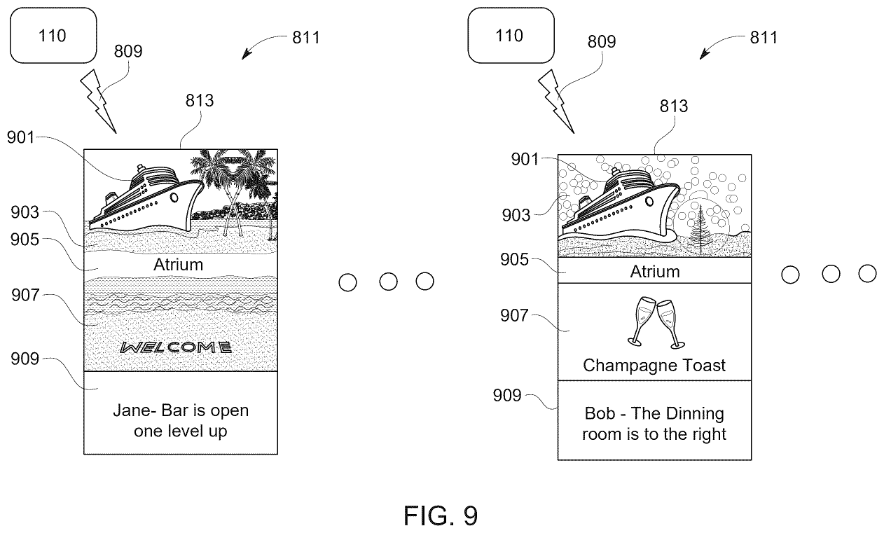

FIG. 9 shows an implementation of the experience platform system 100 according to the present disclosure for content management shown in FIG. 8. As shown in FIG. 9, individual displays 813 receive integrated content data 809 from the experience controller 110 and display personalized and customized information corresponding to the viewer of the display 813. For example, display 813 may be a personal mobile device, a screen or other display that may be associated with or detect the presence of a particular individual. The display 813 is preferably preferentially viewable by the identified individual to provide customized integrated content data 809 for that individual. As shown, the information may be fully personalized and customized to the individual. For example, display 813 may include brand information 901 corresponding to the desired imagery for the brand. In addition, the theme information 903 corresponding to a particular theme corresponding to a particular ship and/or individual. Further the display 813 may show informational text 905 that may include useful information, such as a location or description. The display 813 in this embodiment also shows event information 907 that provides a description and/or imagery regarding an event that is chosen based upon the individual's preferences, the individual's selections or predicted preferences. In addition, dynamic messaging 909 may be displayed providing real-time information, such as directions based upon the individual's location or weather conditions or crowd/queuing information. Each of the displays shows the customized information for the individual and can be updated in real time.

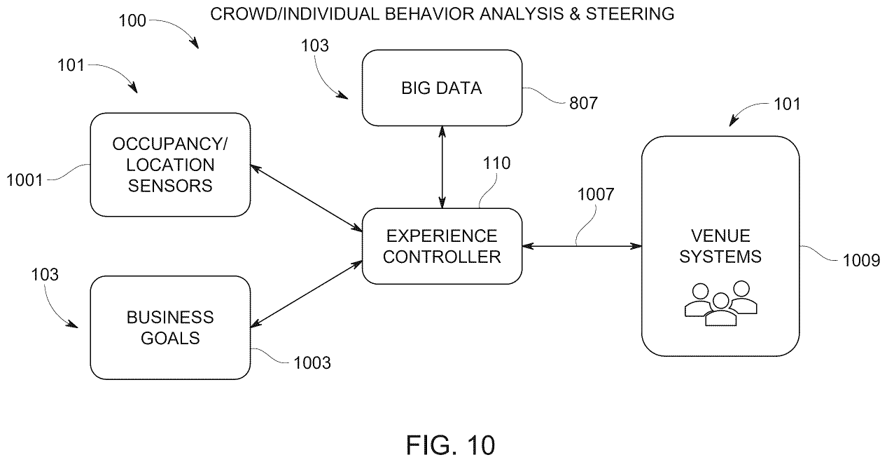

FIG. 10 shows a schematic view of an exemplary embodiment of an experience platform system 100 according to the present disclosure for crowd and/or individual behavior analysis and steering for a public space, entertainment venue, live event or amusement park. As shown in this embodiment, information is measured and collected by occupancy/location sensors 1001. The occupancy/location sensors 1001 are physical world elements 101 that are capable of determining, measuring and/or collecting information on individuals and/or groups of individuals. For example, the occupancy/location sensors 1001 may be computer vision (CV) cameras that collect virtual images of a particular space for analysis to determine individual crowd behavior or condition. Other sensors, such as, but not limited to, global positioning systems (GPS), cell tower triangulation, wi-fi positioning, RFID tags, Bluetooth beacons, radar, lidar, physical sensors (e.g., accelerometers, gyroscopes, magnetometers), which permit the determination of location/position, typically through an individual's mobile device (e.g., smart phone). Data from the occupancy/location sensors 1001 are transmitted to the experience controller 110. In addition, business goals 1003 are likewise transmitted to the experience controller 110. Business goals 1003 are a virtual world element 103 that includes profile information that informs the system on what business direction or goals for the business are desired. For example, the business goals 1003 may include preferences for minimum occupancies or demographics of individuals. Other business goals 1003 may include merchandise targets or experiential goals/value that can be achieved by crowd or individual behavior analysis and/or steering. The experience controller 110 utilizes the virtual world element 103 of big data 1005 to integrate the data from the physical world element 101 and the virtual world element 103 of the business goals 1003 to provide crowd/individual behavior control data 1007. The experience controller 110 outputs crowd/individual behavior control data 1007 to venue system 1009. The venue system 1009 includes any controllable element present in the venue. For example, may include display screens, mobile devices, entry controls, sound systems, lighting, wayfinding or other control systems that influence individual behavior. For example, the crowd/individual behavior control data 1007 may include push notifications indicating that an individual should move to a particular room or may provide information about desirable opportunities in another location. In other embodiments, the crowd/individual behavior control data 1007 may include announcements that provide information to influence individual or crowd behavior (e.g., instructions or directions on where to move). Displays may also provide door or room change information. Lighting may be changed in a manner that alerts or directs individuals in a particular location (e.g., turning down lighting in areas that the venue wishes to have people move from). In addition, wayfinding may be provided to alter signs and/or displays to pull individuals or crowds in directions that are desired.

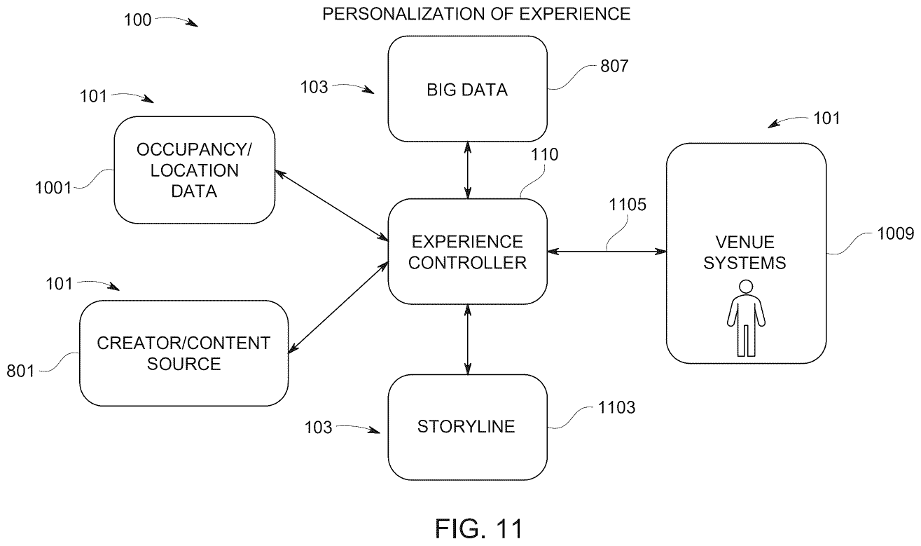

FIG. 11 shows a schematic view of an exemplary embodiment of an experience platform system 100 according to the present disclosure for personalization of an experience for a public space, entertainment venue, live event or amusement park. As shown in this embodiment, information is measured and collected by occupancy/location sensors 1001. Like shown and described with respect to FIG. 10, the occupancy/location sensors 1001 are physical world elements 101 that are capable of determining, measuring and/or collecting information on individuals and/or groups of individuals. Data from the occupancy/location sensors 1001 are transmitted to the experience controller 110. Like shown and described with respect to FIG. 8, a creator designs themes, for example themed adventures for spectators or participants. The resultant creator/content source 801 is transmitted to the experience controller 110. Storyline 1103 is a virtual world element 103 that includes information that changes the content (from the creator/content source 801) to move individuals in the direction desired for their specific experience (e.g., their customized adventure). The experience controller 110 utilizes the virtual world element 103 of big data 807 to integrate the data from the physical world element 101 of the occupancy/location data 1001 and the virtual world element 103 of the creator/content source 801 and the virtual world element 103 of storyline 1103 to provide personalized experience data 1105. The experience controller 110 outputs personalized experience data 1105 to venue system 1009. Like in FIG. 10, the venue system 1009, for example, may include display screens, mobile devices, entry controls, sound systems, lighting, wayfinding or other control systems that provide a personalized experience. For example, the personalized experience data 1105 may include push notifications providing instructions for an individual according to the content and storyline, as applied to the individual. In other embodiments, the personalized experience data 1105 may include announcements that provide information regarding the storyline (e.g., instructions or directions on the next quest). Displays may also provide door or room change information. Lighting may be changed in a manner that enhances the experience. In addition, wayfinding may be provided to alter signs and/or displays to pull individuals in directions that are desired or according to the content and storyline.

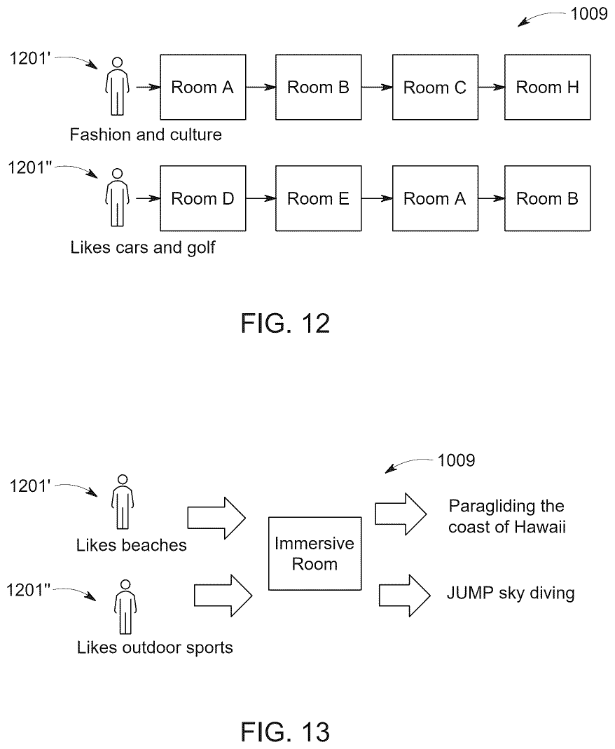

FIGS. 12 and 13 illustrate examples of how the venue systems 1009 may be personalized/customized. As described and shown in FIG. 11, the experience platform system 100 according to the present disclosure may be provided to influence or control the movements of individuals 1201′, 1201″. As shown in FIG. 12, a first individual 1201′ has an experience where movement is encouraged from Room A to Room B to Room C to Room D. A second individual 1201″ has an experience where movement is encouraged from Room D to Room E to Room A to Room B. The differences in the experiences (i.e., the order of the room entries) are due to, for example, storyline 1103 as it applies to each of individual 1201′ and individual 1201″. Other factors may include, for example, occupancy/location data 1001 as it applies to each of individual 1201′ and individual 1201″. FIG. 13 shows another embodiment, wherein the venue system 1009 may include a single room, but individual experiences for first individual 1201′ and second individual 1201″ (e.g., paragliding vs. sky diving).

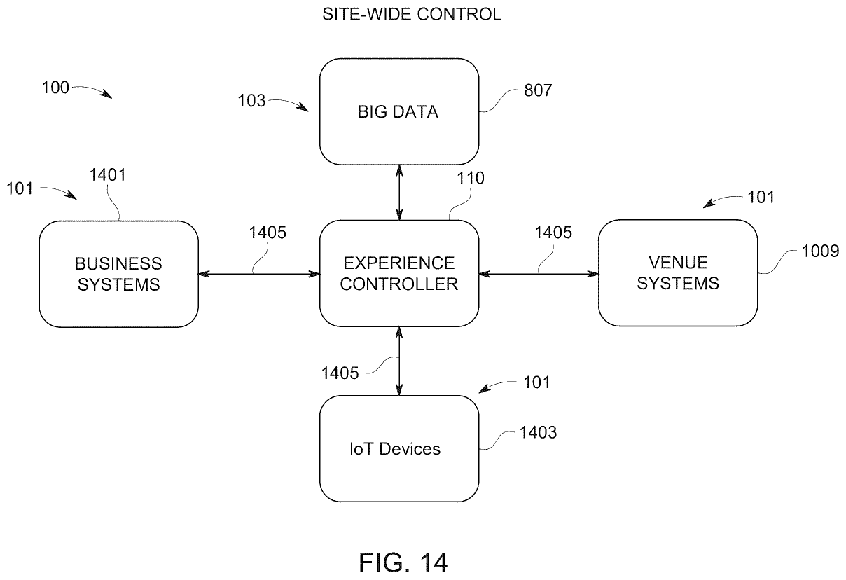

FIG. 14 shows a schematic view of an exemplary embodiment of an experience platform system 100 according to the present disclosure for site-wide control for an entertainment venue or amusement park. Site-wide control may, for example, define, program and schedule an entire theme park, public space, airport or city. The experience platform system 100 according to the present disclosure allows free exchange of information between systems providing an integrated site-wide control. Such integration permits the customer to have a frictionless or near frictionless experience. In addition, the system permits a utilization and an increased value of all display screens and/or projections. As shown in this embodiment, business systems 1401, internet of things (IoT) devices 1403 and venue systems 1009 communicate with experience controller 110.

Business systems 1401, as utilized herein, includes systems that may be utilized to operate a business. Exemplary business systems may include, but are not limited to, ticketing systems, food & beverage systems, merchandise and retails systems, parking systems, access control systems, security/surveillance systems, building management systems, and staffing/HR systems. Internet of things (IoT) devices, as utilized herein, includes a network of physical devices, vehicles, appliances, and/or other objects embedded with sensors, software, and other technologies that enable them to connect to the internet and exchange signals, data and/or information with each other. These devices can collect, send, and receive data, allowing them to be monitored, controlled, and automated remotely. IoT devices 1403 are generally physical world elements 101 but may include virtual world elements 103.

The experience controller 110 utilizes the virtual world element 103 of big data 807 to integrate the data from the physical world element 101 of the business systems 1401, the internet of thing devices 1403 and the venue systems 1009 to provide site-wide control of the business systems 1401, IoT devices 1403 and venue systems 1009. The control signals 1405 from the experience controller 110 to the business systems 1401, the internet of thing devices 1403 and the venue systems 1009 may, for example, may provide personalized, customized and/or adaptive content, control, signals, data and/or information to provide a personalized, customized and/or adaptive experience. Like in FIG. 10, the venue system 1009, for example, may include display screens, mobile devices, entry controls, sound systems, lighting, wayfinding or other control systems that provide a personalized experience. For example, the personalized experience data 1105 may include push notifications providing instructions for an individual according to the content and storyline, as applied to the individual. In other embodiments, the personalized experience data 1105 may include announcements that provide information regarding the storyline (e.g., instructions or directions on the next quest).

Such controls may be useful for enhancing the guest experience or may be utilized in emergency situations to guide guests to safety. Displays may also provide door or room change information. Lighting may be changed in a customized manner in real-time that enhances the experience. In addition, wayfinding may be provided to alter signs and/or displays to pull individuals in directions that are desired or according to the content and storyline. The integration of the IoT devices 1403, business system 1401, big data 807 and venue systems, permits real-time, site-wide control of the venue, allowing a beneficial personalized experiences for the individual as well as significant operational advantages for the owners and operators of the venue.

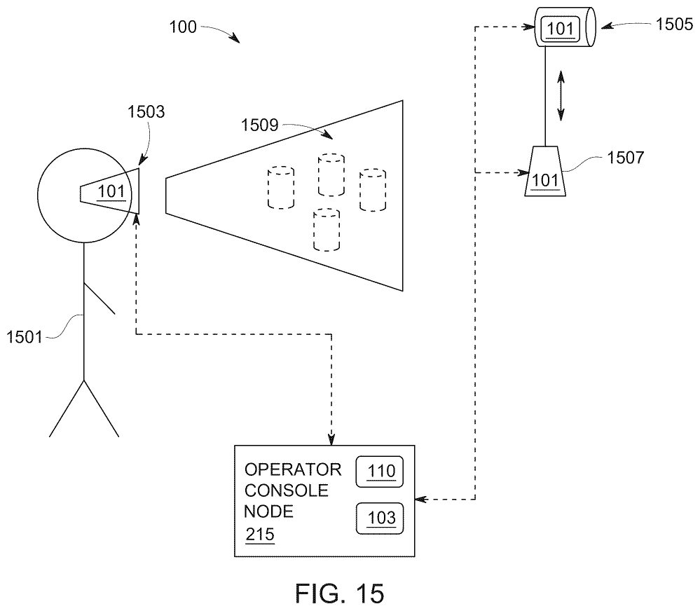

FIG. 15 shows a schematic view of an exemplary embodiment of an experience platform system 100 according to the present disclosure shows a schematic view of an embodiment of the present disclosure showing an individual 1501 wearing an AR headset 1503 in an adaptive physical environment. More particularly, as shown in FIG. 18, the controller 110 integrates data, signals and information from physical world elements 101 and virtual world elements 103 to control a winch 1505 and a lighting element 1407 as well as provide AR content 1509 for AR headset 1503. For example, position, location and gesture recognition data transmitted from the AR headset 1503 to operator console node 215. Position, location and status data for winch 1505 and lighting element 1507 are likewise transmitted from winch 1505 and lighting element 1507 to operator console node 215. The data, signals and/or information received by operator console node 215 is integrated with the experience controller 110 and transmitted back to the AR headset 1503 (i.e., in the form of personalized content for display), the winch 1505 (i.e., in the form of control instructions for raising or lowering the lighting element 1505) and the lighting element 1507 (i.e., in the form of customized lighting patterns). The resultant control provides a customized/personalized experience integrating the visuals provided to the individual through the AR headset 1503, while simultaneously altering the physical environment with control of the winch 1505 and lighting element 1507. While the system of FIG. 15, is shown with one individual 1501, AR headset 1503, winch 1505 and lighting element 1507, the disclosure is not so limited and may include any number of individuals 1501, AR headsets 1503, winches 1505 and lighting elements 1507, which may all be simultaneously controlled to provide individual, customized, real-time experiences for the individuals 1501.

Other features and advantages of the present invention will be apparent from the following more detailed description of the preferred embodiment, taken in conjunction with the accompanying drawings which illustrate, by way of example, the principles of the invention.

While the exemplary embodiments illustrated in the figures and described herein are presently preferred, it should be understood that these embodiments are offered by way of example only. Accordingly, the present application is not limited to a particular embodiment, but extends to various modifications that nevertheless fall within the scope of the appended claims. The order or sequence of any processes or method steps may be varied or re-sequenced according to alternative embodiments.

It is important to note that the construction and arrangement of the various exemplary embodiments is illustrative only. Although only a few embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited in the claims. For example, elements shown as integrally formed may be constructed of multiple parts or elements, the position of elements may be reversed or otherwise varied, and the nature or number of discrete elements or positions may be altered or varied. Accordingly, all such modifications are intended to be included within the scope of the present application. The order or sequence of any process or method steps may be varied or re-sequenced according to alternative embodiments. In the claims, any means-plus-function clause is intended to cover the structures described herein as performing the recited function and not only structural equivalents but also equivalent structures. Other substitutions, modifications, changes and omissions may be made in the design, operating conditions and arrangement of the exemplary embodiments without departing from the scope of the present application.

1. An experience platform system comprising:
a physical world element;
a virtual world element; and
an experience controller integrating the physical world element and the virtual world element;
wherein the integrating includes real-time control of one or both of the physical world element and the virtual world element.

2. The experience platform system of claim 1, wherein the integrating includes real-time control of the physical world element includes a response to a condition of the virtual world element.

3. The experience platform system of claim 1, wherein physical world elements include one or both of a building management system (BMS) and a content management system (CMS).

4. The experience platform system of claim 1, wherein physical world elements may be selected from the group consisting of motors, drivers, cameras, computer vision (CV), sensors, lighting elements, sound/acoustic elements, pyrotechnic elements, video screens, point of sale systems, mobile devices, wearables and combinations thereof.

5. The experience platform system of claim 1, wherein virtual world elements may be selected from the group consisting of user profiles, virtual spaces, virtual models, simulators, physics engines, game engines, avatars, applications, big data, artificial intelligence, and combinations thereof.

6. The experience platform system of claim 1, wherein the integrating includes providing a feature selected from the group consisting of individual wayfinding in a venue, individual content management of a venue system, individual content management of a customer interface, crowd behavior analysis and steering, site-wide control and combinations thereof.

7. A method for providing an experience for a guest, the method comprising:
providing a physical world element;
providing a virtual world element; and
integrating the physical world element and the virtual world element to provide control of one or both of the physical world element and the virtual world element.

8. The method of claim 7, wherein the integrating includes real-time control of the physical world element includes a response to a condition of the virtual world element.

9. The method of claim 7, wherein physical world elements include one or both of a building management system (BMS) and a content management system (CMS).

10. The method of claim 7, wherein physical world elements may be selected from the group consisting of motors, drivers, cameras, computer vision (CV), sensors, lighting elements, sound/acoustic elements, pyrotechnic elements, video screens, point of sale systems, mobile devices, wearables and combinations thereof.

11. The method of claim 7, wherein virtual world elements may be selected from the group consisting of user profiles, virtual spaces, virtual models, simulators, physics engines, game engines, avatars, applications, big data, artificial intelligence, and combinations thereof.

12. The method of claim 7, wherein the integrating includes providing a feature selected from the group consisting of individual wayfinding in a venue, individual content management of a venue system, individual content management of a customer interface, crowd behavior analysis and steering, site-wide control and combinations thereof.

13. An experience platform system for providing control of one or both of the physical world element and the virtual world element, the system comprising:
a plurality of nodes and an operator console node in communication with each other over a real time network;
one or both of a node of the plurality of nodes or the operator console node corresponds to the physical world element;
one or both of a node of the plurality of nodes or the operator console node corresponds to virtual world element;
each node of the plurality of nodes and the operator console node comprising a microprocessor and a memory device, the operator console node further comprising an integrator for integrating the physical world element and the virtual world element; and
wherein the system provides real-time control of the physical world element in response to the integration of the physical world element and the virtual world element.

14. The experience platform system of claim 13, further comprising a node process in the memory of a node including instruction executable by the microprocessor to control the physical world element.

15. The experience platform system of claim 13, wherein the integration of the physical world element and the virtual world element includes real-time control of the physical world element includes a response to a condition of the virtual world element.

16. The experience platform system of claim 13, wherein physical world elements include one or both of a building management system (BMS) and a content management system (CMS).

17. The experience platform system of claim 13, wherein physical world elements may be selected from the group consisting of motors, drivers, cameras, computer vision (CV), sensors, lighting elements, sound/acoustic elements, pyrotechnic elements, video screens, point of sale systems, mobile devices, wearables and combinations thereof.

18. The experience platform system of claim 13, wherein virtual world elements may be selected from the group consisting of user profiles, virtual spaces, virtual models, simulators, physics engines, game engines, avatars, applications, big data, artificial intelligence, and combinations thereof.

19. The experience platform system of claim 13, wherein the integration of the physical world element and the virtual world element includes providing a feature selected from the group consisting of individual wayfinding in a venue, individual content management of a venue system, individual content management of a customer interface, crowd behavior analysis and steering, site-wide control and combinations thereof.
